(19) United States
(12) Patent Application Publication
(10) Pub. No.: US 2026/0264220 A1
(43) Pub. Date: Sep. 10, 2026

(54) CONTINUUM ROBOT, HUB ASSEMBLY, SUPPORTER, AND METHODS OF USE THEREOF

(71) Applicant: CANON U.S.A., INC., Melville, NY (US)

(72) Inventors: Anne Yujin Edge, Somerville, MA (US); Inderpal Singh, Norwood, MA (US)

(21) Appl. No.: 19/075,503

(22) Filed: Mar. 10, 2025

(51) Int. Cl. B25J 9/00; B25J 18/06

(52) U.S. Cl. CPC B25J 9/0021; B25J 18/06

(57) ABSTRACT

Disclosed are a continuum robot, a hub assembly, a supporter, and methods of use thereof, with the hub including a distal end, a proximal end, a plurality of clamp rods extending between the distal end and the proximal end, and a supporter. In a disengaged state, the supporter is spaced apart from the proximal end of the hub. In an engaged state, at least a part of each clamp rod of the plurality of clamp rods extends from the proximal end through the supporter.

### CROSS-REFERENCE TO RELATED APPLICATION(S)

None.

### FIELD OF THE DISCLOSURE

The present disclosure relates generally to continuum robots, hub assemblies, supporters, and methods of use thereof.

### BACKGROUND OF THE DISCLOSURE

A continuum robot (a/k/a snake) includes a plurality of bending sections having a flexible structure, with the shape of the continuum robot being controlled by deforming the bending sections. The snake has significant advantages over existing robots including rigid link robots. An advantage is that the snake can move along a curve in a narrow space or in an environment with scattered objects in which the rigid link robot may get stuck. Another advantage is that it is possible to operate the snake without damaging surrounding fragile elements, utilizing intrinsic flexibility of the snake.

Various related art disclosures in the field include U.S. Pat. No. 11,559,190, which discusses a steerable device with push-pull actuators and breakout unit, as well as WO 2022/146751, which discusses a steerable snake with push-pull rod structure. U.S. 2022/0202277 discusses a medical apparatus having a bendable body with a driving wire, a/k/a tendon; a break-out wire attached to the driving wire, with a distal end of the break-out wire attached to a proximal end of the driving wire; a distal guide tube guiding the driving wire and ending before the break-out wire with a space; a resilient element abutting the driving wire along at least a portion of a longitudinal direction of the driving wire; and an actuator configured to retract and advance the driving wire via the break-out wire thereby maneuvering the bendable body.

When controlling the bendable medical device by pushing or pulling the drive wires, the amount of operating force that can be applied to the drive wires is limited by a buckling force of the specific wire diameter and material. For the bendable medical device, space constraints imposed by target anatomy, tool dimensions, and the like, required use of wires having small diameter. To prevent wire buckling, continuous support may be provided around the drive wires throughout the entire length of the bendable medical device. U.S. 2015/0142013 discusses releasing tension from the continuum robot pull wires with a button/command for the continuum robot shape to conform to the anatomy.

U.S. 2023/0372666 discusses an actuator connection method where the catheter outer shell includes a rotating collar for locking over a corresponding pin on the actuation unit.

U.S. 2024/0189048 discusses a medical apparatus that includes a base unit with a drive source therein, and a bendable unit that is to be detachably attached to the base unit. The bendable unit includes a connection unit including a first member connected to the drive source and a second member connected to a linear member.

U.S. 2024/0189048 discusses a catheter unit with a wire cover with cover and exposure positions. Movement of the wire cover between the cover/exposure positions shields/exposes portions of drive wires.

However, conventional systems and methods do not provide a supporter that is moveable when connecting a hub to a continuum robot, with the supporter being is spaced apart from a proximal end of the hub in the longitudinal direction when in a disengaged state and at least a part of each clamp rod of the plurality of clamp rods extends from the proximal end through the supporter in the longitudinal direction when in an engaged state.

### SUMMARY

Thus, to prevent wire buckling, continuous support around the drive wires throughout an entire length of the bendable medical device is provided.

An aspect of the present disclosure provides a hub for connecting a continuum robot with an actuator, the hub including a distal end, a proximal end, a plurality of clamp rods extending between the distal end and the proximal end, and a supporter. To connect the hub to the continuum robot, the distal end extends towards the continuum robot and the proximal end extends towards the actuator. In a disengaged state, the supporter is spaced apart from the proximal end of the hub, and in an engaged state, at least a part of each clamp rod of the plurality of clamp rods extends from the proximal end through the supporter.

Another aspect of the present disclosure provides a method of connecting a continuum robot to an actuator, the method including grasping an outer shell of a hub provided on a proximal end of the continuum robot; aligning ends of a plurality of clamp rods extending in a longitudinal direction from a proximal end of the hub with respective clamps of the actuator; and joining the plurality of clamp rods with the respective clamps by pressing, in the longitudinal direction, the hub against the actuator. The outer shell has an asymmetrical shape, and the pressing overcomes a force applied by a resilient member against an axial supporter that extends in the longitudinal direction between the plurality of clamp rods.

A further aspect of the present disclosure provides a supporter that is configured to facilitate connecting a hub of a continuum robot to an actuator, the hub includes a plurality of clamp rods extending in the longitudinal direction, the supporter includes a proximal side facing the actuator; a distal side facing the hub; and a plurality of holes extending through the supporter in the longitudinal direction, wherein the plurality of holes being arranged in a substantially circular shape, with each hole of the plurality of holes being positioned to align with and support a respective clamp rod of the plurality of clamp rods.

Further aspects of the present disclosure are described herein. These and other objects, features, and advantages of the present disclosure will become apparent upon reading the following detailed description of exemplary embodiments of the present disclosure, when taken in conjunction with the appended drawings, and provided paragraphs.

### BRIEF DESCRIPTION OF THE DRAWINGS

Further objects, features and advantages of the present innovation will become apparent from the following detailed description when taken in conjunction with the accompanying figures showing illustrative embodiments of the present innovation.

FIG. 1 is a block diagram of an exemplary medial system including ancillary components and a bendable medical device.

FIG. 2 illustrates components of a continuum robot.

FIG. 3 illustrates relative arrangement of the actuator, hub and catheter shaft of the continuum robot.

FIG. 4 is a profile view illustrating components of a catheter hub.

FIG. 5 is a perspective view of an actuator prior to loading of the catheter hub.

FIG. 6 illustrates partial loading of the catheter hub into the actuator.

FIG. 7 illustrates a supporter, according to an embodiment of the present disclosure.

FIG. 8 is a perspective view of a supporter of FIG. 7, positioned on proximal ends of clamp rods extending from the hub, according to an embodiment of the present disclosure.

FIG. 9 is a perspective of the supporter, disengaged from the hub, according to an embodiment of the present disclosure.

FIG. 10 is a perspective view of the supporter with a plurality of axial supporters, according to an embodiment of the present disclosure.

FIG. 11 is a side view of the hub and actuator, including the supporter, in a disengaged state, according to an embodiment of the present disclosure.

FIG. 12 is a side view of the hub and actuator, including the supporter, in an engaged state, according to an embodiment of the present disclosure.

FIG. 13 is a perspective view of the supporter 14 in the disengaged state, according to an embodiment of the present disclosure.

FIG. 14 is a perspective view of the supporter and axial supporter, according to an embodiment of the present disclosure.

FIG. 15 is a side view of the hub, including the supporter, in an engaged state, according to another embodiment of the present disclosure.

FIG. 16 is a perspective view of the supporter in the disengaged state, according to the other embodiment of the present disclosure.

FIG. 17 is a side view of the hub, including the supporter, in an engaged state, according to a further embodiment of the present disclosure.

FIG. 18 is a perspective view of the supporter in the disengaged state, according to the further embodiment of the present disclosure.

FIG. 19 is a side view of the supporter in the disengaged state, according to the further embodiment of the present disclosure.

FIG. 20 is a perspective view of the hub and actuator, according to another embodiment of the present disclosure.

FIG. 21 is a cutaway view of the embodiment of FIG. 20, in the disengaged state.

FIG. 22 is a cutaway view of the embodiment of FIG. 20, in the engaged state.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

In the subject disclosure, systems and mechanisms of a continuum robot are described, followed by continuum robot support elements for reducing buckling, as well as the systems and procedures associated with the continuum robot and said support elements.

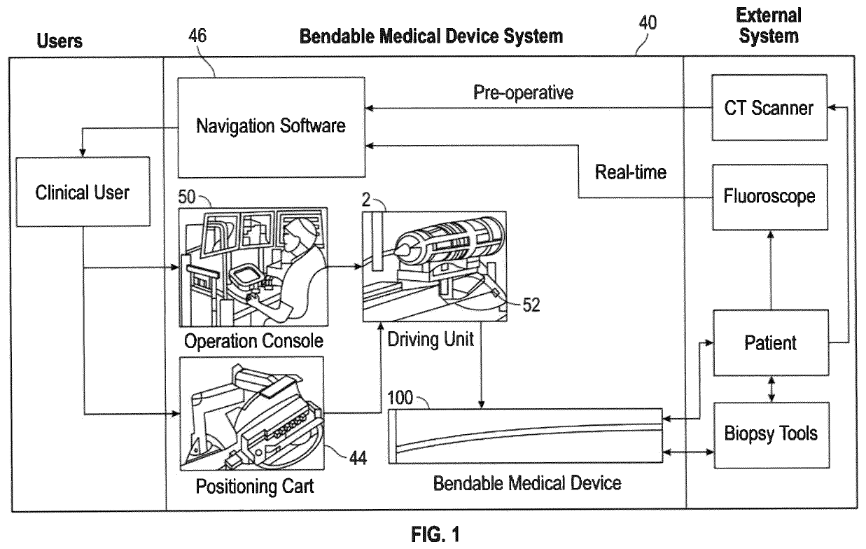

FIG. 1 is a block diagram of an exemplary medial system including ancillary components and a bendable medical device.

As illustrated in FIG. 1, the system 40 includes a driving unit 2 (also referred to as an actuator or driver) for driving the drive wires or tendons (also referred to as drive wire, drive wires, or driver(s)), and having a base stage 52, a continuum robot 100 (also referred to as bendable medical device, steerable catheter, snake, or robotic catheter), a positioning cart 44, an operation console 50 (also referred to as controller or control system), having push-button, thumb-stick, and/or joystick, and navigation software 46. The system 40 is capable of interacting with external system components and clinical users to facilitate use in a patient.

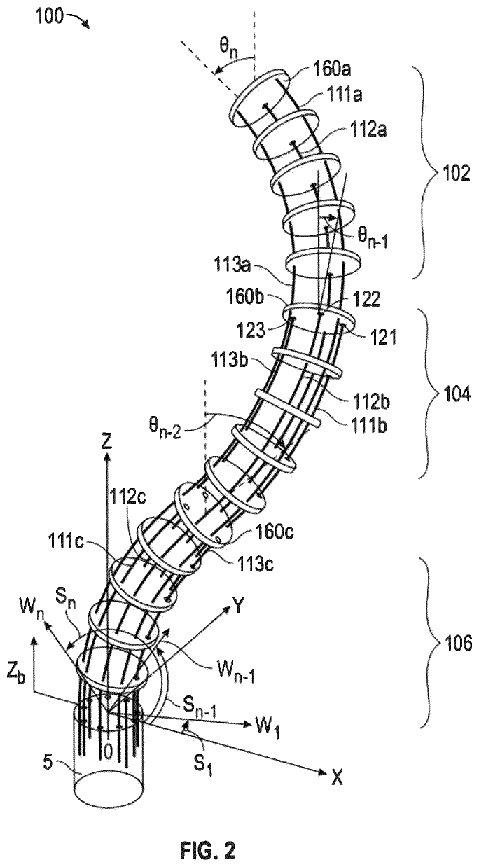

FIG. 2 illustrates components of a continuum robot. As shown in FIG. 2, the continuum robot 100 includes push/pull drive wires 111b, 112b and 113b, which are connected to connection portions 121, 122 and 123, respectively, found on an end disc 160b, for controlling the middle bending section 104. Additional drive wires (three for each of the other bendable sections 102 and 106) 111a, 111c, 112a, 112c, 113a, 113c, are attached at the distal ends of each bendable section 102 and 106, to the respective end disc 160a and 160c. Each bending section is similarly operated. Thus, the description of one bending section, i.e., the middle bending section 104, will be recognized to apply to the other sections. Posture of the bending section 104 is controlled by pushing and pulling the wires 111b to 113b by using actuators, with l_{D}=the length of the central axis a bending section; θₙ=the bending angle of the distal end; ξₙ=the rotational angle of the distal end; ρₙ=the radius of curvature of a bending section. Drive wires 111a . . . c, 112a . . . c, 113a . . . c are also referred to as at least one drive wire 4 herein.

The continuum robot 100 attaches to a catheter shaft 5, a/k/a bendable part, which may be disposed on a base stage 52 (FIG. 1) and can be moved by the base stage 52 in the longitudinal direction, to advance, retard and/or retract the continuum robot 100 into a target structure by advancing, retarding and/or retracting the base stage 52.

An operation console 50 may indicate a driving amount to the base stage 52 and, independently, to the actuator 2. The operation console 50 may include dedicated hardware including a field-programmable gate array (FPGA) and the like; and/or may be a computer including a storage unit, a work memory, and a central processing unit (CPU). Where the operation console 50 is a computer, the storage unit may be a memory that stores a software program corresponding to a control system algorithm and the CPU may expand the program in the work memory, and may execute the program line by line, for the computer to function as the operation console 50. In either case, the operation console 50 may communicably connect with the base stage 52 and the actuator 2, and the operation console 50 may send signals representing the driving amount and configuration to these control targets, which may be imputed by an end user through push buttons, joystick or the like. Thus, the continuum robot 100 includes at least one distal bending section 102, with robotic control for insertion and removal of the continuum robot 100 from the target for operation during lung biopsies, medical procedures, and similar operations.

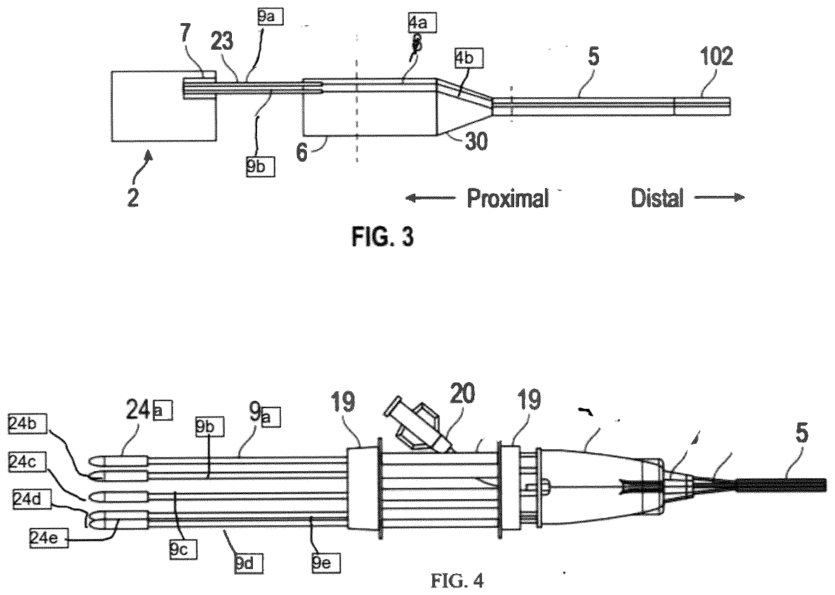

FIG. 3 illustrates relative arrangement of the actuator, hub and catheter shaft of the continuum robot.

Posture and/or pose of the catheter shaft 5 may be controlled by push/pull on at least one drive wire 4. The catheter shaft 5, a/k/a bendable part, has at least one distal bending section 102, with at least three drive wires terminating in each of the at least one distal bending section 102 to control bend angle and plane. The actuator 2 may selectively push/pull the at least one drive wire 4 to control the distal bending section 102. The at least one drive wire 4 may be spaced apart from another at least one drive wire 4 at a pitch diameter of 22 mm.

Clamp rods 9 that extend from the hub 6 may be attached/detached by clamping performed by an actuator clamp 7 of the actuator 2, for removable attachment of a hub body 6 to the actuator 2 and controller (operation console 50). The clamp rods may be 2.3 mm OD polycarbonate tubes, provided at a 70 mm length from the hub 6.

The clamp rods 9 attach/detach from respective clamps 7, with the clamp rods 9 being fixedly attached to the proximal end of respective driving wires 4. The at least one drive wire 4 may slide within respective support sleeves, a/k/a hypotubes, which are anchored at distal ends of the hub body 6, with the drive wires 4 being slidable within the catheter shaft 5.

As illustrated in FIG. 3, the hub body 6 may have a straight section at a proximal end thereof. The hub body 6 transitions from a proximal end of the pitch diameter that substantially aligns with the actuator clamps 7 to a distal end of the pitch diameter that substantially aligns with a diameter of the catheter shaft 5.

At a proximal end of the transition, a proximal end of the at least one drive wire 4 may be exposed to connect to a push/pull assembly of the actuator 2 and the controller. For connection to the push pull assembly, supporting small wires and hypotubes which are pushed with up to 20 N force must be supported. Also, an increased wire diameter is used to removable clamping with high clamp strength via a clamp rod 9.

At the distal end, the at least one drive wire 4 connects to the catheter shaft and a strong bond between the hub and catheter shaft is created in limited space.

FIG. 4 is a profile view illustrating components of a catheter hub.

As shown in FIG. 4, a tool channel 20 may be provided within the hub body 6. The tool channel 20 may extend an entire working length of the catheter 5, allowing utilization of tools inserted therethrough during operation of the continuum robot. One or more stationary hub guide disks 19 may be provided in the hub body 6.

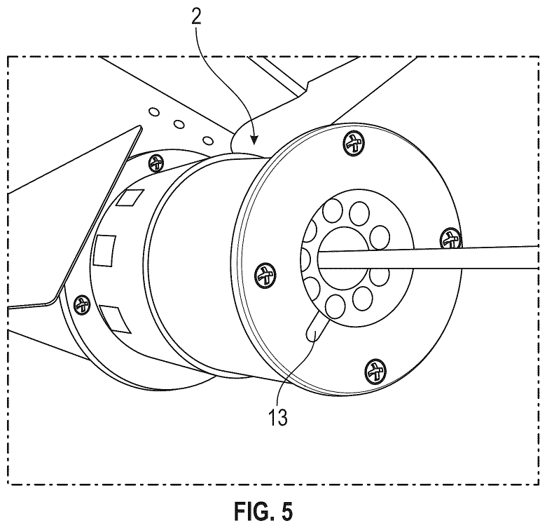

FIG. 5 is a perspective view of an actuator prior to loading of the catheter hub.

As shown in FIG. 5, the actuator includes a plurality of holes that align in a longitudinal direction with respective clamps 7, which are configured to fixedly secure a respective clamp rod 9 when the hub 6 is joined with the actuator 2.

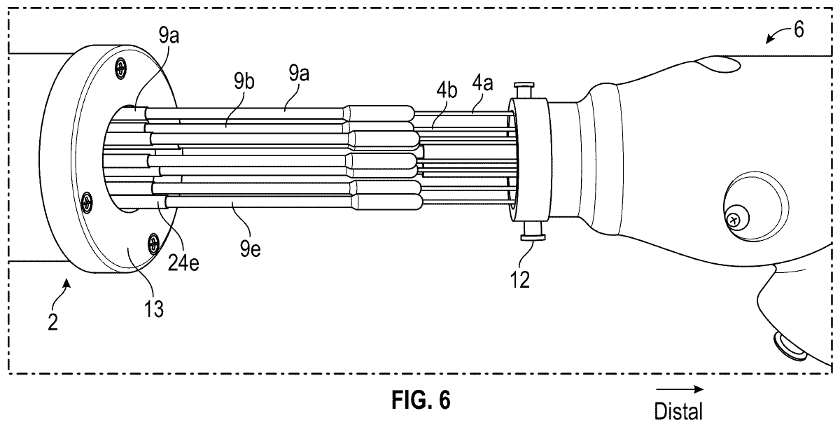

FIG. 6 illustrates partial loading of the catheter hub into the actuator.

As shown in FIG. 6, clamp rods 9a . . . 9d extending from a proximal end of the hub 6 are aligned with respective holes of the plurality of holes, as shown in FIG. 5. Also shown in FIG. 6 are bullet shaped tips 24 provided on a distal end of each clamp rod 9. When the hub 6 is joined (loaded) with the actuator 2, each tip 24 aligns with a respective clamp 7 of the actuator 2. Securing the clamps 7 to the respective tips 24 allows each respective tractor of the actuator 2 to push/pull the respective drive wire 4.

In addition, FIG. 6 illustrates tab 12 and recess 13, with tab 12 being provided on the proximal end of the hub 6 and recess 13 being provided on a distal end of the actuator. Upon joining hub 6 with the actuator 2, the tab 12 will fit into the recess 13, to prevent rotation of the hub 6 relative to the actuator 2.

Loading the hub 6 to the actuator 2 is typically performed by visually aligning each clamp rod 9 into the corresponding actuator clamp 7. To maximize alignment of functionality, each clamp rod 9 and corresponding actuator clamp 7 is held stationary while the hub 6 is pushed in the longitudinal direction to move the clamp rods 9 into the corresponding actuator clamps 7. Such operation may be delayed by movement of one or more of the clamp rods 9 in a transverse direction that is substantially perpendicular to the longitudinal direction. Loading the hub 6 may also be delayed any clamp rod 9 is initially out of alignment, which may occur due to the distance that the clamp rods 9 extend from the proximal end of the hub in an unsupported manner.

After loading a few clamp rods 9, it may become difficult to prevent previously aligned clamp rods 9 from slipping out of position, since alignment of each of the nine clamp rods 9 is needed before simultaneous sliding of the nine clamp rods 9 can occur. Also, the actuator 2 may be set up at a downward angle, thereby obscuring a view of the actuator clamps 7 when attempting to align the clamp rods 9 therein.

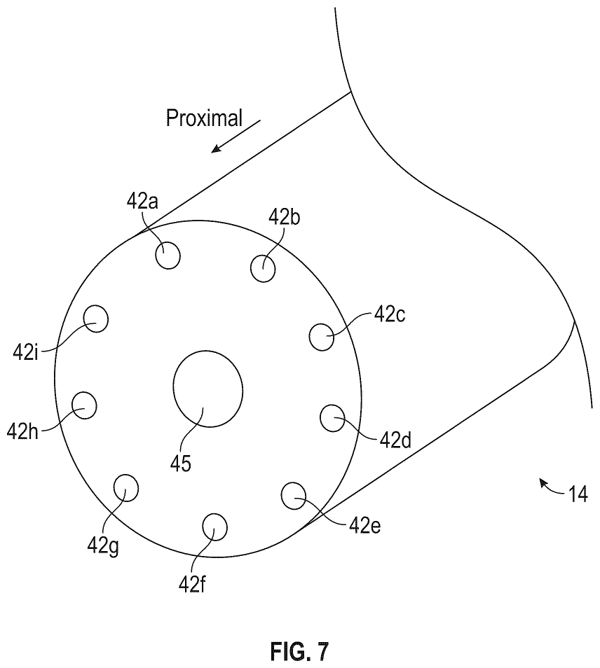

FIG. 7 is a perspective view of a supporter, according to an embodiment of the present disclosure.

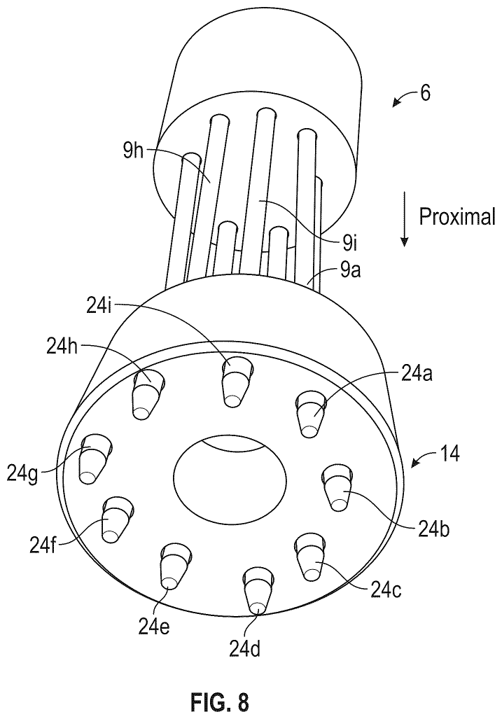

FIG. 8 is a perspective view of a supporter of FIG. 7, positioned on proximal ends of clamp rods that extending from the hub 6, according to an embodiment of the present disclosure.

The supporter 14 may be formed of one or more of a foam, an elastomer, an elastic polymer, a thermoplastic, an unsaturated rubber, a saturated rubber, an organic rubber, an inorganic rubber, or the like. The supporter 14 may have a 30 mm outside diameter with a 2 mm thickness and a 2.5 mm ID snap-in grooves.

Providing the supporter 14 on the proximal end of the clamp rods 9 expedites the simultaneous loading of multiple clamp rods 9 of the hub 6, and thereby loading the continuum robot/catheter, onto the actuator 2.

As illustrated in FIGS. 7 and 8, the supporter 14 includes a plurality of holes 42a . . . i extending in the longitudinal direction. A center hole 45 also extends in the longitudinal direction, surrounded by the plurality of holes 42a . . . i. In the disengaged state, a proximal position along each clamp rod 9 of the plurality of clamp rods extends in the longitudinal direction through a respective hole 42 of the plurality of holes 42a . . . i. In the engaged state, each clamp rod 9 slides in the longitudinal direction through the respective hole 42 from the proximal position to a more distal position that is closer to the hub 6.

The plurality of holes uniformly oppose a transverse force that may be applied in the transverse direction on at least one of the plurality of clamp rods 9a . . . i. The transverse force may be applied in a direction that is substantially perpendicular to the longitudinal direction. By uniformly opposing the transverse force, alignment of the plurality of clamp rods 9a . . . i is maintained.

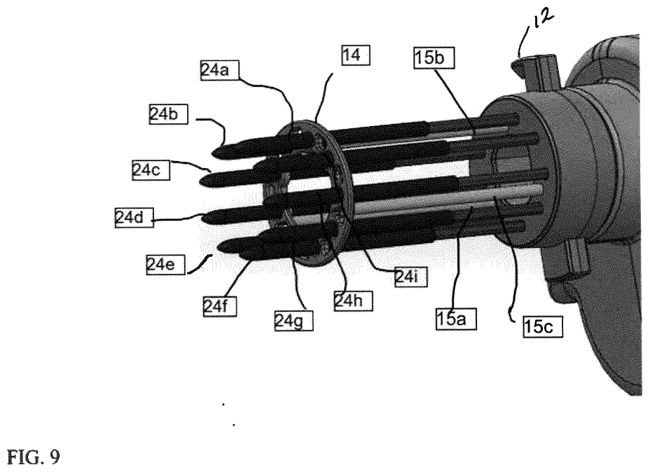

FIG. 9 is a perspective of the supporter, disengaged from the hub, according to an embodiment of the present disclosure.

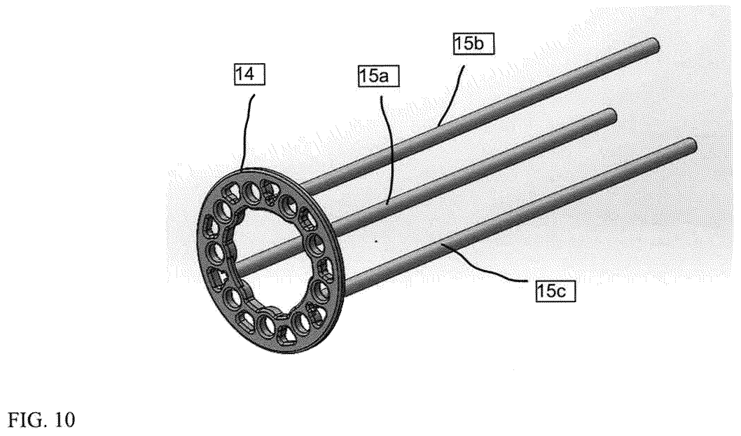

FIG. 10 is a perspective view of the supporter with a plurality of axial supporters, according to an embodiment of the present disclosure.

As illustrated in FIG. 9, a plurality of tips 24a . . . i may be provided, with one tip on a proximal end of each respective clamp rod. Each of the plurality of tips 24a . . . i may be elongated longitudinally corresponding to travel of the supporter 14.

Also illustrated in FIG. 9 and FIG. 10 the plurality of holes that are provided in the supporter 14 may have varied shape, including but not limited to a circle, a semi-circle, a substantially triangle shape, a substantially trapezoidal shape. As illustrated in FIG. 10, the holds may vary in shape, and the variation in shape may be provided in a predetermined pattern.

As illustrated in FIGS. 9 to 10, a plurality of axial support rods 15a . . . c may be fixed on one end to the supporter 14. The other end of each axial support rod 15a . . . c may be configured to slide into a support rod guide channel 16 in the hub 6 as the supporter moves between the disengaged state and the engaged state.

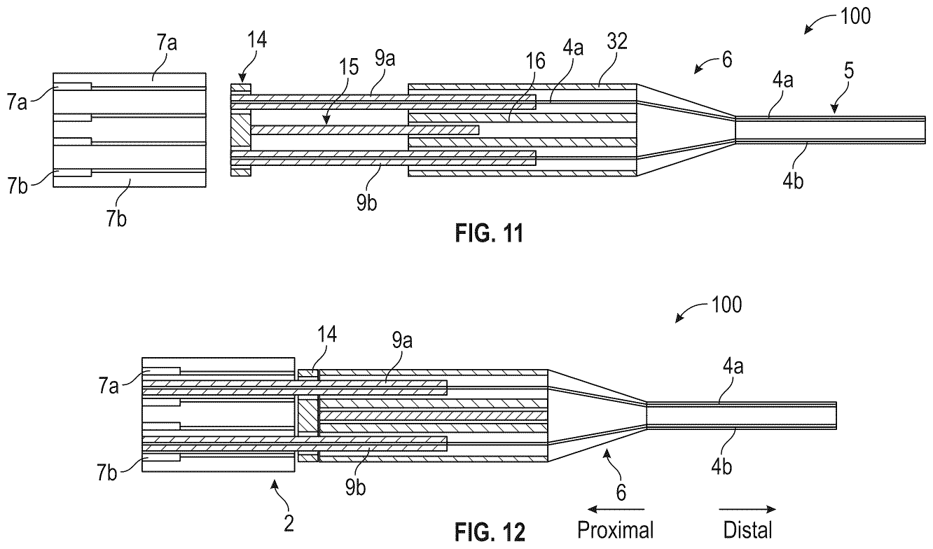

FIG. 11 is a side view of the hub, including the supporter, in a disengaged state, according to an embodiment of the present disclosure.

FIG. 12 is a side view of the hub, including the supporter, in an engaged state, according to an embodiment of the present disclosure.

As illustrated in FIGS. 11 and 12, the hub 6 may connect a catheter/continuum robot with the actuator 2, with the hub 6 including a distal end and a proximal end that is opposite to the distal end in the longitudinal direction. The hub 6 also includes a supporter 14 and a plurality of clamp rods 9a . . . i. The plurality of clamp rods 9a . . . i extend in the longitudinal direction between the distal end and the proximal end. To connect the hub 6 to the continuum robot 100, the distal end extends towards the continuum robot 100 and the proximal end extends towards the actuator 2.

As illustrated in FIG. 11, when in a disengaged state, the supporter 14 is spaced apart from the proximal end of the hub 6 in the longitudinal direction. As illustrated in FIG. 12, when in an engaged state, at least a part of each clamp rod 9 of the plurality of clamp rods 9a, 9b extends from the proximal end through the supporter 14 in the longitudinal direction. At least one hub guide channel 32 is provided to accommodate distal ends of the clamp rods 9 therein.

The supporter 14 may be formed in a substantially disk shape. As illustrated in FIGS. 7 and 8, the supporter 14 may be formed of compressible material. In the engaged state, at least a part of a face of the supporter 14 contacts the proximal end of the hub 6 to compress the supporter 14 against the proximal end of the hub 6. The supporter 14 may be formed of a substantially disk shaped compressible material. In the disengaged state, the hub 6 is separated from the actuator 2 and the supporter 14 is spaced apart from a proximal end of the hub 6 in the longitudinal direction. In the engaged state, the hub 6 is joined with the actuator 2, with at least a part of each clamp rod 9 of the plurality of clamp rods 9a . . . i extending from the proximal side of the supporter 14 into the actuator 2, and with at least a part of the proximal side of the supporter 14 contacting a distal side of the actuator 2. To transition from the disengaged state to the engaged state, the supporter 14 slides in the longitudinal direction along the plurality of clamp rods 9a . . . i toward the proximal end of the hub 6.

FIG. 11 is a side view of the hub and actuator, including the supporter, in a disengaged state, according to an embodiment of the present disclosure.

FIG. 12 is a side view of the hub and actuator, including the supporter, in an engaged state, according to an embodiment of the present disclosure.

To transition from the disengaged state of FIG. 11 to the engaged state of FIG. 12, the supporter 14 moves in the longitudinal direction toward the proximal end of the hub 6 along the plurality of clamp rods 9a . . . i. In the disengaged state, the supporter 14 is spaced apart from the proximal end of the hub 6 in the longitudinal direction. When transitioning from the disengaged state to the engaged state, each clamp rod of the plurality of clamp rods 9 will slide along a respective hole of the plurality of holes 42a . . . i.

As also illustrated in FIG. 12, each proximal end of each clamp rod of the plurality of clamp rods 9 is configured to extend into the actuator 2 in the longitudinal direction and each distal end of each clamp rod 9 slidably extends into the hub 6 in the longitudinal direction. For clarity, tip 24 that may be provided on each proximal end of each clamp rod is not illustrated in FIG. 11 or FIG. 12.

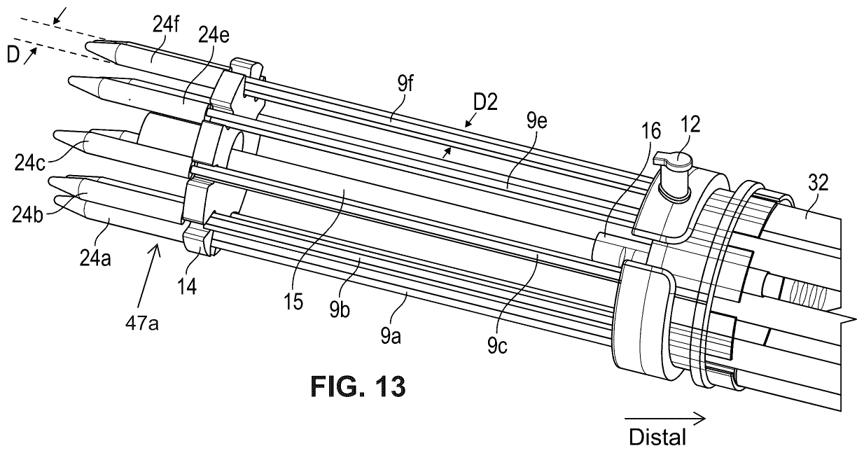

FIG. 13 is a perspective view of the supporter 14 in the disengaged state, according to an embodiment of the present disclosure.

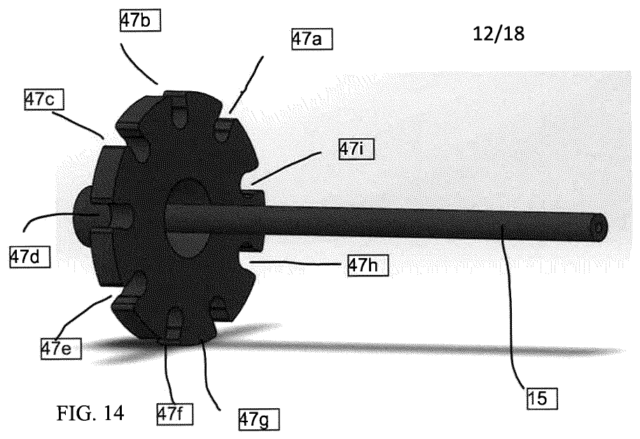

FIG. 14 is a perspective view of the supporter and axial supporter, according to an embodiment of the present disclosure.

As illustrated in FIG. 13, at least the tip 24 at each proximal end of each clamp rod has a first diameter D₁. A portion of each clamp rod 9a . . . 9d that is distal from each proximal end has a second diameter D₂. A diameter of each hole Dh (FIG. 7) of the plurality of holes is less than the first diameter and greater than or equal to the second diameter. For example, the supporter 14 may have a 30 mm outside diameter, have a 25 mm thickness when uncompressed, and have a 3 mm thickness when compressed. Each hole of the plurality of holes may have a 2.5 mm diameter (ID), to create a friction fit over the tips 11 having a 3.0 mm diameter.

The actuator 2 may include a recess therein of a 3 mm depth that compresses the supporter 14 be a predetermined amount when in the engaged state, i.e., locked.

After a predetermined number of uses (e.g., a one-time, single use), the compressible supporter 14 will be located adjacent to the hub 6. The supporter 14 may be configured to retain a deformation after compression. Thus, for disposable catheters, maintaining the deformation provides an indication that the catheter has already been used, thereby avoiding inadvertent re-use thereof.

The supporter 14 may be formed of a compressible material and the plurality of holes 42a . . . i may extend through the compressible material in the longitudinal direction. Based on the relative sizing, at least hole of the plurality of holes 42a . . . i will exert a binding force, e.g. friction, that will slidably affix or hold a respective clamp rod positioned therein. Thus, each hole of the plurality of holes 42a . . . i slideably secures a respective clamp rod 9 therein.

As illustrated in FIGS. 10 to 13, an axial support rod 15 is provided is fixed on one end to the supporter 14. Another end the axial support rod 15 is configured to slide into a support rod guide channel 16 in the hub 6 as the supporter moves between the disengaged state and the engaged state.

As illustrated in FIGS. 13 and 14, outer portions of each hole may be removed to form a substantially C shaped groove 47a . . . i, thereby leaving a perimeter that is majority closed. Thus, the supporter 14 may be mounted onto the clamp rods/tips by snapping each clamp rod/tip into a respective groove. FIG. 14 illustrates the outer portions of each hole having been removed to form the grooves, within which the clamp rod 9 or tip 24 may slide, as described herein.

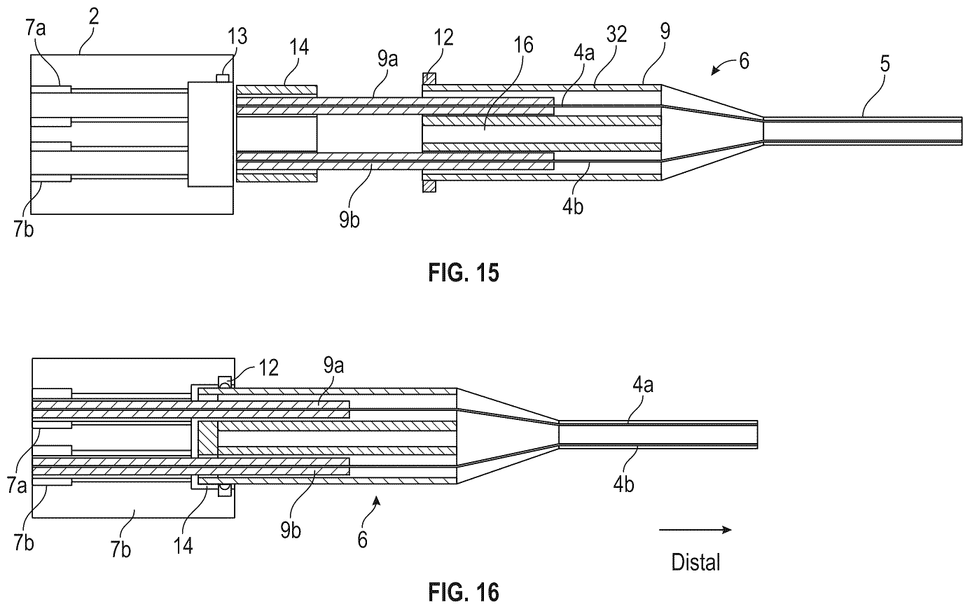

FIG. 15 is a side view of the hub, including the supporter, in an engaged state, according to another embodiment of the present disclosure.

FIG. 16 is a perspective view of the supporter 14 in the disengaged state, according to the other embodiment of the present disclosure.

As illustrated in FIGS. 15 and 16, at least a part of a face of the supporter 14, which in this embodiment may be formed of compressible material, contacts and compresses against the proximal end of the hub 6 in the engaged state.

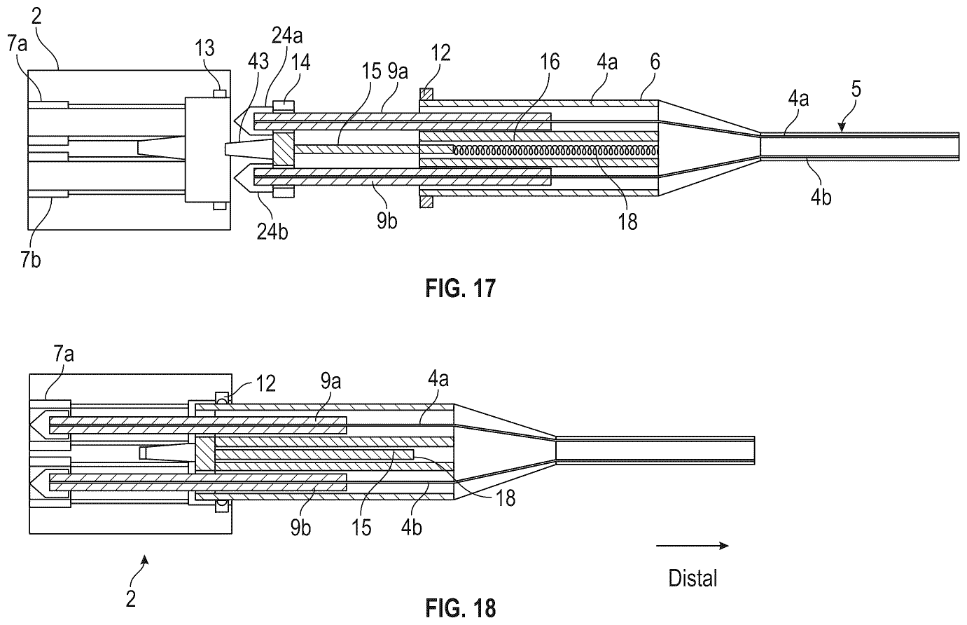

FIG. 17 is a side view of the hub, including the supporter, in an engaged state, according to a further embodiment of the present disclosure.

FIG. 18 is a perspective view of the supporter 14 in the disengaged state, according to the further embodiment of the present disclosure.

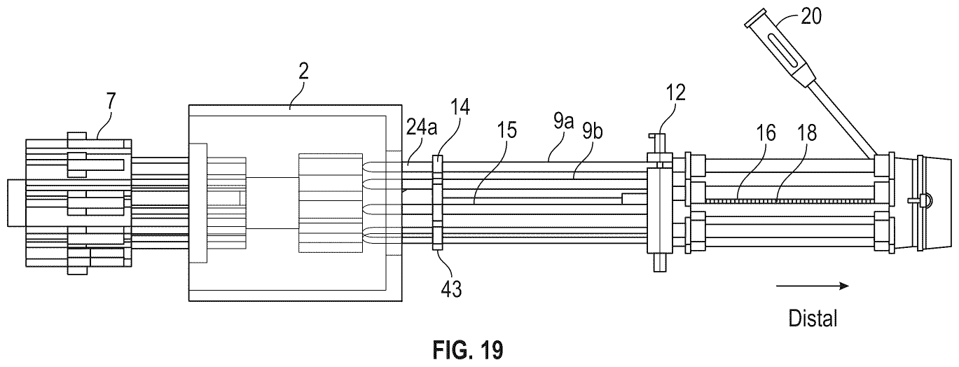

FIG. 19 is a side view of the supporter 14 in the disengaged state, according to the further embodiment of the present disclosure.

As illustrated in FIGS. 17-19, a resilient member 18 is provided in the support rod guide channel 16. An axial support rod 15 is provided having one end fixed to the supporter 14 and another end slidable engaged with a support rod guide channel 16 of the hub 6. The another end of the axial support rod 15 slides within the support rod guide channel 16 as the supporter 14 moves between the disengaged state and the engaged state.

The resilient member 18 may apply a force in the longitudinal direction on the another end of the axial supporter 15. The force applied by the resilient member 18 disposes locating the support disk 14 at the proximal end of the clamp rods 9, to promote alignment.

In the disengaged state, the force applied by the resilient member 18 presses the supporter 14 against proximal ends of each clamp rod of the plurality of clamp rods 9a . . . i. In the engaged state, the force at least one of maintains and/or presses the supporter 14 against proximal ends of each clamp rod of the plurality of clamp rods 9a . . . i. When transitioning from the disengaged state to the engaged state, both the axial supporter 15 and the supporter 14 move in the longitudinal direction toward the proximal end of the hub 6.

The resilient member 18 may be formed from one or more of a spring formed of plastic and/or metal, an elastomer, an elastic polymer, a thermoplastic, an unsaturated rubber, a saturated rubber, an organic rubber, an inorganic rubber, and the like.

The resilient member 18 may be configured to fit within the support rod guide channel 16. A free length of the resilient member 18 may fill the void within the support rod guide channel 16, to prevent the resilient member 18 from sliding back into the support rod guide channel 16 when the catheter is not loaded into the actuator 2. A compressed length of the resilient member 18 allows the full length of the clamp rods 9 to be inserted and locked into the respective actuator clamps 7. The resilient member 18 may have a low spring force, to facilitate manual compression thereof by a user during loading.

As illustrated in FIGS. 17-19, the axial support rod 15 extends in the longitudinal direction between the plurality of clamp rods 9a . . . i.

As also illustrated in FIGS. 17-19, a proximal side of the hub 6 may include a tab 12 that is positioned to engage an opposing recess 13, which is provided on the actuator 2. Alternatively, the tab and recess may be provided on the hub 6 and the actuator 2, respectively. Engagement of the tab 12 into the recess 13 secures and precludes rotation of the hub 6 relative to the actuator 2.

As illustrated in FIGS. 17 and 18, tab 12 may be provided along an outer perimeter of hub 6 and recess 13 is similarly positioned. As also illustrated in FIGS. 14 and 15, a protrusion 43 may be provided extending from a proximal face of supporter 14. When the supporter 14 moves from the disengaged state to the engaged state, the protrusion 43 is positioned within a receiving recess within the actuator 2. As illustrated in FIGS. 14 and 15, the protrusion 43 and the receiving recess may have matching conical shapes, to assist in joining the hub 6 into the actuator 2. The force applied by the resilient member 18 presses the protrusion 43 against and into the receiving recess.

Accordingly, a supporter 14 is provided to facilitate connecting a hub 6 of a continuum robot 100 to an actuator 2. The hub 6 may include a plurality of clamp rods 9a . . . i extending in a longitudinal direction. The supporter 14 may include a proximal side facing the actuator 2, a distal side facing the hub 6, and a plurality of holes 42a . . . i that extend through the supporter 14 in the longitudinal direction. The plurality of holes 42a . . . i may be arranged in a substantially circular shape, with each hole of the plurality of holes 42a . . . i being positioned to align with a respective clamp rod of the plurality of clamp rods 9a . . . i.

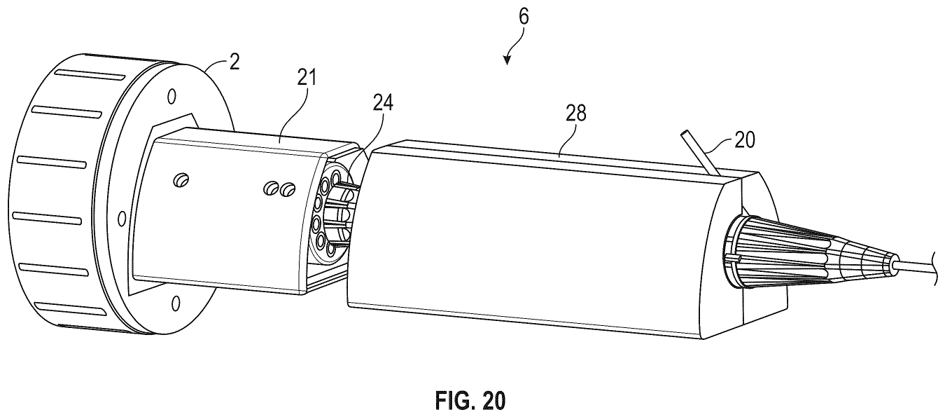

FIG. 20 is a perspective view of the hub 6 and actuator 2, according to another embodiment of the present disclosure.

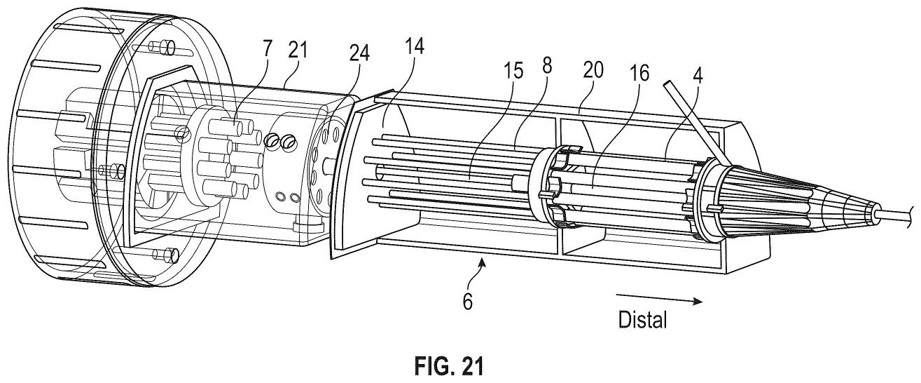

FIG. 21 is a cutaway view of the embodiment of FIG. 20, in the disengaged state.

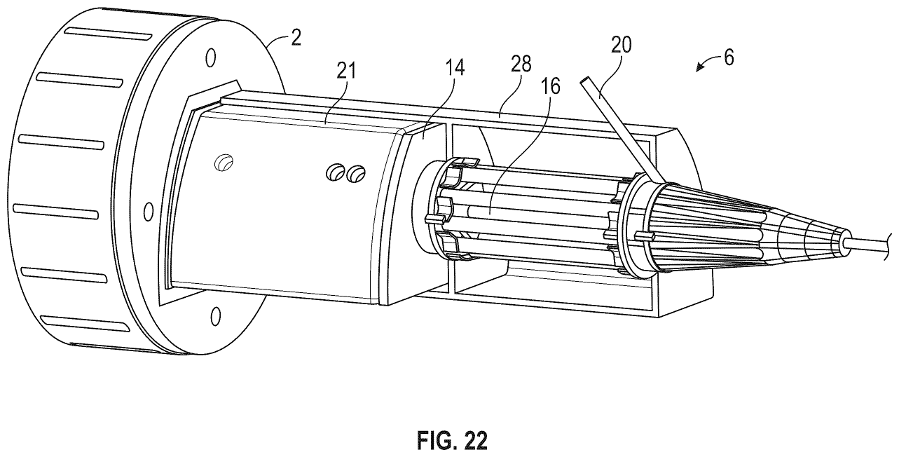

FIG. 22 is a cutaway view of the embodiment of FIG. 20, in the engaged state.

As illustrated in FIGS. 20-22, the hub 6 may include an outer shell 28, and the supporter 14 may have an asymmetrical, i.e. non-circular, outer shape. At least a portion of the outer shell may have an inner shape that corresponds to, i.e., matches the asymmetrical outer shape of the supporter 14. The outer shell 28 is configured for a user to grasp. The outer shell 28 is provided on the hub 6, i.e. at a proximal end of the continuum robot 100.

The matching asymmetrical shape of the outer shell 28 with the supporter 14 allows the outer shell 28 to slide over the actuator housing 21 in a specific orientation. The asymmetrical outer shell 28 may extend to or past the supporter 14. The asymmetrical outer shell 28 may matches the actuator housing 21.

The actuator housing 21 may also have a corresponding asymmetrical shape for the actuator 2 to lock onto the outer shell 28 after full insertion. The supporter 14 may also have a corresponding asymmetrical shape, to facilitate sliding within the outer shell 28 while prevention independent rotation. The supporter 14 may press against a distal face of the housing 21, and slide along an inner surface of the outer shell 28.

The matching asymmetrical shapes allow for visual alignment by a user and facilitates easy and intuitive loading while maintain a specific orientation.

The outer shell 28 encloses and protects the clamp rods 9 from damage during assembly, transport, unpacking, loading, etc., thereby providing a robust design.

For disposable catheters, all catheter-contacting surfaces on the actuator housing must be cleaned after each use. The outer shell 28 provide easy cleaning, at least because it is easier to wipe down an external surface on the actuator housing 21, rather than wiping down internal slots or grooves.

To connect a continuum robot 100 to an actuator 2, a user grasps an outer shell 28 of a hub 6 that is provided on a proximal end of the continuum robot 100. The user then aligns ends of a plurality of clamp rods 9a . . . i that extend in the longitudinal direction from the proximal end of the hub 6 with respective clamps 7 of the actuator 2. Then, the user joins the plurality of clamp rods 9a . . . i with the respective clamps 7 by pressing, in the longitudinal direction, the hub 6 against the actuator 2. The outer shell 28 may have an asymmetrical shape, and the pressing overcomes a force applied by a resilient member 18 against an axial supporter 15 that extends in the longitudinal direction between the plurality of clamp rods 9a . . . i.

In the disengaged state, the supporter 14 presses against the ends of the plurality of clamp rods 9a . . . i, with the supporter 14 being spaced apart from the proximal end of the hub 6 in the longitudinal direction. In the engaged state, at least a part of each clamp rod of the plurality of clamp rods extends from through the supporter 14 into the actuator 2. The force maintains the supporter 14 in the disengaged state. The resilient member 18 is enclosed in a support rod guide channel 16 within the hub 6.

The supporter 14 may have an asymmetrical outer shape corresponding to a shape of an inner hollow of the outer shell 28 of the hub 6. In response to the pressing in the longitudinal direction of the hub 6 against the actuator 2, the asymmetrical outer shape of the supporter 14 slides along the corresponding asymmetrical shape of the inner hollow of the outer shell 28. The sliding of the asymmetrical outer shape of the supporter 14 along the corresponding asymmetrical shape of the inner hollow of the outer shell 28 maintains a predefined orientation of the continuum robot 100 and the actuator 2.

The continuum robot, the hub, the spacer, and the methods of use of the present application may be useful in in various service and industrial fields, such as medical diagnostics, surgery, hazardous operations such as bomb disposal, manufacture, repair, inspection, maintenance, including performing diagnostics and/or of engines, turbines, aircraft, ships, robots, underground ducts, power plants, rescue sites, and other applications of transport in narrow and/or tortuous environs, without limitation thereto.

### REFERENCE NUMBERS

| | |
|---|---|
| 2 | Actuator |
| 4, 111, 112, 113 | push/pull drive wires |
| 5 | Bendable part |
| 6 | Hub |
| 7 | Clamp |
| 9 | Clamp rod |
| 12 | Tab |
| 13 | Recess |
| 14 | Supporter |
| 15 | Axial supporter |
| 16 | Support rod guide channel |
| 18 | Resilient member |
| 19 | Hub guide disks |
| 20 | Tool channel |
| 21 | Actuator housing |
| 24 | Tip |
| 28 | Outer shell |
| 32 | Hub guide channel |
| 40 | System |
| 42 | Holes |
| 43 | Protrusion |
| 44 | Positioning cart |
| 45 | Center hole |
| 46 | Navigation software |
| 47 | Groove |
| 50 | Operation console |
| 52 | Base stage |
| 100 | Continuum robot |
| 102, 104, 106 | Bending sections |
| 121, 122, 123 | Connection portions |
| 160 | End disc |

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. Skilled artisans may employ such variations as appropriate, and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed:

1. A hub for connecting a continuum robot with an actuator, the hub comprising:
a distal end;
a proximal end;
a plurality of clamp rods extending between the distal end and the proximal end; and
a supporter, wherein:
in a disengaged state, the supporter is spaced apart from the proximal end of the hub, and
in an engaged state, at least a part of each clamp rod of the plurality of clamp rods extends from the proximal end through the supporter.

2. The hub of claim 1, wherein:
the supporter is formed of a compressible material, and
in the engaged state, at least a part of a face of the supporter contacts the proximal end of the hub.

3. The hub of claim 1, wherein, to transition from the disengaged state to the engaged state, the supporter moves toward the proximal end of the hub along the plurality of clamp rods.

4. The hub of claim 1, wherein:
the supporter comprises at least one of a plurality of holes and/or a plurality of grooves, and
each clamp rod extends through a respective hole of the at least one of the plurality of holes and/or the plurality of grooves.

5. The hub of claim 4, wherein the at least one of the plurality of holes and/or the plurality of grooves are configured to oppose a transverse force applied on at least one of the plurality of clamp rods.

6. The hub of claim 4, wherein:
in the disengaged state, the supporter is spaced apart from the proximal end of the hub, and
to transition from the disengaged state to the engaged state, each clamp rod of the plurality of clamp rods slides along a respective hole or groove.

7. The hub of claim 4, wherein:
each proximal end of each clamp rod of the plurality of clamp rods is configured to extend into the actuator, and
each distal end of each clamp rod extends into the hub.

8. The hub of claim 4, wherein:
each proximal end of each clamp rod has a first diameter,
a portion of each clamp rod distal from the each proximal end has a second diameter, and
a diameter of each hole or groove is less than the first diameter and greater than or equal to the second diameter.

9. The hub of claim 1, wherein:
the supporter is formed of a compressible material with at least one of a plurality of holes and/or a plurality of grooves extending in the longitudinal direction through the compressible material, and
each of the at least one of the plurality of holes and/or the plurality of grooves is configured to slideably at least one of support and/or secure a respective clamp rod therein.

10. The hub of claim 9, wherein:
at least one hole or groove has a diameter less than an outer diameter of a clamp rod provided therein, and
the compressible material exerts a binding force on the outer diameter of the clamp rod.

11. The hub of claim 1, further comprising at least one axial supporter extending in the longitudinal direction between the plurality of clamp rods.

12. The hub of claim 11, wherein, when transitioning from the disengaged state to the engaged state, both the at least one axial supporter and the supporter move toward the proximal end of the hub.

13. The hub of claim 11, further comprising at least one resilient member configured to apply a force on an end of a respective one of the at least one axial supporter.

14. The hub of claim 13, wherein, in the disengaged state, the force applied by the resilient member presses the supporter against proximal ends of each clamp rod of the plurality of clamp rods.

15. The hub of claim 13, wherein, in the engaged state, the force maintains contact between at least a part of the supporter and a proximal end of at least one clamp rod.

16. The hub of claim 13, wherein:
a proximal side of the hub includes a tab configured to engage an opposing recess provided on the actuator,
the force applied by the at least one resilient member presses the tab against the opposing recess, and
engagement of the recess to the opposing tab secures the hub to the actuator.

17. The hub of claim 1, further comprising an outer shell, wherein:
the supporter has an asymmetrical outer shape, and
at least a portion of the outer shell has an inner shape corresponding to the asymmetrical outer shape of the supporter.

18. A method of connecting a continuum robot to an actuator, the method comprising:
grasping an outer shell of a hub provided on a proximal end of the continuum robot;
aligning ends of a plurality of clamp rods extending in a longitudinal direction from a proximal end of the hub with respective clamps of the actuator; and
joining the plurality of clamp rods with the respective clamps by pressing, in the longitudinal direction, the hub against the actuator, wherein:
the outer shell has an asymmetrical shape, and
the pressing overcomes a force applied by a resilient member against an axial supporter that extends in the longitudinal direction between the plurality of clamp rods.

19. The method of claim 18, wherein the resilient member is enclosed within a support rod guide channel of the hub.

20. The method of claim 18, further comprising a supporter, wherein:
in a disengaged state, the supporter is configured to press against the ends of the plurality of clamp rods, with the supporter spaced apart from the proximal end of the hub, and
in an engaged state, at least a part of each of the plurality of clamp rods extends through the supporter into the actuator.

21. The method of claim 20, wherein the force maintains the supporter in the disengaged state.

22. The method of claim 20, wherein the supporter has an asymmetrical outer shape corresponding to a shape of an inner hollow of the outer shell of the hub.

23. The method of claim 22, wherein, in response to the pressing in the longitudinal direction of the hub against the actuator, the asymmetrical outer shape of the supporter slides along the corresponding asymmetrical shape of the inner hollow of the outer shell.

24. The method of claim 23, wherein sliding the asymmetrical outer shape of the supporter along the corresponding asymmetrical shape of the inner hollow of the outer shell maintains a predefined orientation of the continuum robot and the actuator.

25. A supporter configured to facilitate connecting a hub of a continuum robot to an actuator, the hub including a plurality of clamp rods extending in a longitudinal direction, the supporter comprising:
a proximal side facing the actuator;
a distal side facing the hub; and
a plurality of holes extending through the supporter in the longitudinal direction, wherein:
the plurality of holes are arranged in a substantially circular shape, and
each hole of the plurality of holes is positioned to align with and support a respective clamp rod of the plurality of clamp rods.

26. The supporter of claim 25, wherein:
in a disengaged state, the hub is separated from the actuator with the supporter being spaced apart from a proximal end of the hub,
in an engaged state, the hub is joined with the actuator, with:
(a) at least a part of each clamp rod of the plurality of clamp rods extending from the proximal side of the supporter into the actuator, and
(b) at least a part of the proximal side of the supporter contacting a distal side of the actuator, and
the supporter slides along the plurality of clamp rods toward the proximal end of the hub to transition from the disengaged state to the engaged state.
